(19) United States
(12) Patent Application Publication
(10) Pub. No.: US 2012/0134916 A1
(43) Pub. Date: May 31, 2012

(54) HIGH-TEMPERATURE SCR CATALYST

(76) Inventors: Joseph M. Fedeyko, Glen Mills, PA (US); Arthur J. Reining, Christiana, PA (US); Hai-Ying Chen, Conshohocken, PA (US); Paul J. Andersen, Plymouth Meeting, PA (US)

(21) Appl. No.: 13/036,823

(22) Filed: Feb. 28, 2011

(51) Int. Cl. B01J 29/85; B01D 53/56; C01B 39/54

(52) U.S. Cl. 423/700; 502/74; 502/60; 423/239.2

(57) ABSTRACT

A catalyst comprising: (a) a microporous crystalline molecular sieve comprising at least silicon, aluminium and phosphorous and having an 8-ring pore size; and (b) a transition metal loaded in the molecular sieve, the transition metal loading is less than about 1 wt %.

### FIELD OF INVENTION

The invention relates generally to emission control of high-temperature exhaust streams, and, more specifically, to a catalyst that facilitates high temperature NOx reduction with high selectivity.

### BACKGROUND

Electric utility power plants and other stationary fuel-burning facilities such as industrial boilers, waste incinerators, and manufacturing plants are a significant source of combustion process air pollutants. Pollutants of particular interested formed by these stationary combustion sources are nitrogen oxides, also called NOx gases. Nitrogen oxide or nitric oxide (NO) and nitrogen dioxide (NO2) are the normal constituents of NOx. These compounds play a significant role in the atmospheric reactions that create harmful particulate matter, ground-level ozone (smog), acidifying nitrate deposition (acid rain), ozone depletion, and greenhouse effects. Consequently, NOx from stationary combustion sources have been subject to increasingly more stringent regulatory requirements over the past three decades, and emission standards are likely to be tightened in the future.

Although NOx formation can be controlled to some extent by modifying combustion conditions, current techniques for NOx removal from combustion flue gas normally utilize post-combustion treatment of the hot flue gas by Selective Catalytic Reduction (SCR). The Selective Catalytic Reduction procedure utilizes a catalytic bed or system to treat a flue gas stream for the selective conversion (reduction) of NOx to N2. The SCR procedure normally utilizes ammonia or urea as a reactant that is injected into the flue gas stream upstream, prior to their being contacted with the catalyst. SCR systems in commercial use typically achieve NOx removal rates of over 80%.

While SCR is an effective way of reducing NOx emissions in combustion flue streams, high-temperature applications pose certain challenges. For example, natural gas powdered turbines typically have exhaust temperatures that range between 800 and 1200° F. and require high conversions of NOx at low inlet concentration (<100 ppm NOx). SCR catalysts used in high temperature applications under low inlet NOx concentration require extremely high selectivity of NOx over NH3 to achieve both NOx conversion and NH3 slip targets.

A traditional catalyst for high-temperature SCR applications is vanadia based. Vanadia catalysts, however, tend to be particularly susceptible to degradation at exhaust gas temperatures above 950° F. Consequently, systems using vanadium catalyst typically require either strict control of the applications outlet temperature, or the introduction of a cooling system, or both. These restrictions have the effect of increasing capital cost and reducing the efficiency of the system. Therefore, there is a need to develop more durable catalysts to provide simpler and more efficient exhaust systems in stationary generation applications.

As disclosed in WO2008132452 (incorporated herein by reference), small pore molecular sieves such as chazibites have the durability to sustain long-term operation above 950° F. However, to prevent dealumination at such high temperatures, aluminosilicates typically require relatively high loadings of transition metals. For example, typically the transition metal loading must be greater than 1 wt %. Such high loading levels tend to make the catalyst particularly reactive, diminishing its selectively by oxidizing a significant amount of the reductant NH3 above 950° F., thereby limiting the ability of NH3 to reduce NOx and control low levels of NOx at these high temperatures.

Therefore, there is a need for a SCR catalyst that is not only durable for long term operation at high temperatures, but also selectively reduces NOx over oxidizing NH3 at high temperatures. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides a SCR catalyst configured specifically for high-temperature applications. Applicants have discovered that silicoaluminophosphates do not require high loading levels of transition metal (TM) to stabilize the molecular sieve framework against hydrothermal aging. Lower TM loadings can therefore be used to optimize catalyst performance for durability and selectivity. For example, catalysts with a transition metal loadings of less than 1 wt % show excellent durability, undergoing thousands of hours of hydrothermal aging with no significant loss in catalyst performance. Furthermore, because of the TM loadings are so low, the catalyst remains selective even at higher temperatures, thus promoting the reduction of NOx over the oxidation of NH3. Because the catalyst does not deplete NH3 at high temperatures, NH3 remains in the stream as a reductant for NOx. Therefore, a catalyst is described which widens the applicable temperature window of current small pore silicoaluminophosphate molecular sieves to temperatures above 950° F. for low level NOx flue streams, such as those of a gas turbine generator.

Accordingly, one aspect of the invention relates to a microporous molecular sieve catalyst having a low transition metal loading. In one embodiment, the catalyst comprises: (a) a microporous crystalline molecular sieve comprising at least silicon, aluminium and phosphorous and having an 8-ring pore size; and (b) a transition metal (TM) loaded in the molecular sieve, the transition metal being present such that the transition metal loading is less than 1.0 wt %.

Another aspect of the invention relates to a method of using the above-mentioned catalyst in selective catalytic reduction (SCR). In one embodiment, the method comprises: (a) injecting nitrogenous reductant into an exhaust flow from the gas turbine having NOx and a temperature greater than 950 F; (b) contacting the exhaust stream containing reductant with an SCR catalyst to form a NOx-reduced gas stream, the SCR catalyst comprising at least (i) a microporous crystalline molecular sieve comprising at least silicon, aluminium and phosphorous and having an 8-ring pore size; and (ii) a transition metal loaded in the molecular sieve, the transition metal loading being less than 1 wt %.

Aside from the subject matter discussed above, the present disclosure includes a number of other exemplary features such as those explained hereinafter. It is to be understood that both the foregoing description and the following description are exemplary only.

### BRIEF SUMMARY OF DRAWINGS

FIG. 1 shows NOx conversion of low transition metal loaded SAPO-34 materials.

FIG. 2 shows aged performance of a 0.13 wt % Cu loaded SAPO-34 molecular sieve.

FIG. 3 shows a schematic of a stationary generating system.

### DETAILED DESCRIPTION

One embodiment of the present invention is a catalyst comprising: (a) a microporous crystalline molecular sieve comprising at least silicon, aluminum and phosphorous and having an 8-ring pore size; and (b) a transition metal loaded in the molecular sieve, the transition metal being present such that the transition metal loading less than 1 wt % of the catalyst.

Another embodiment of the invention is a method of reducing NOx emission from the exhaust stream of a high-temperate combustion system such as a gas turbine. The method comprises (a) injecting nitrogenous reductant into an exhaust flow from the gas turbine having NOx and a temperature greater than 850° F.; (b) contacting the exhaust stream containing the reductant with an SCR catalyst to form a NOx-reduced gas stream, the SCR catalyst comprising at least (i) a microporous crystalline molecular sieve comprising at least silicon, aluminium and phosphorous and having an 8-ring pore size; and (ii) a transition metal impregnated in the molecular sieve, the transition metal being present in a concentration such that the transition metal loading less than 1 wt % of the catalyst.

These embodiments and exemplary alternatives thereto are described in detailed below.

The hydrothermally-stable microporous crystalline molecular sieve comprises at least silicon, aluminium and phosphorous and has an 8-ring pore opening structure. In one embodiment, the molecular sieve is a silicoaluminophosphate (SAPO) molecular sieve. SAPO molecular sieves are synthetic materials having a three-dimensional microporous aluminophosphate crystalline framework with silicon incorporated therein. The framework structure consists of PO₂₊, AlO₂—, and SiO₂ tetrahedral units. The empirical chemical composition on an anhydrous basis is: mR:(SiₓAl_{y}P_{z})O₂ wherein, R represents at least one organic templating agent present in the intracrystalline pore system; m represents the moles of R present per mole of (SiₓAl_{y}P_{z})O₂ and has a value from zero to 0.3; and x, y, and z represent the mole fractions of silicon, aluminum, and phosphorous, respectively, present as tetrahedral oxides. In one embodiment, silica content is greater than 5%.

In one embodiment, the SAPO molecular sieves have one or more of the following framework types as defined by the Structure Commission of the International Zeolite Association: AEI, AFX, CHA, LEV, LTA, In one embodiment, the framework type is CHA, or CHA in combination with one or more different framework types, such as, for example, AEI-CHA intergrowths. Examples of suitable CHA SAPOs include SAPO-34 and KYT-6. In one embodiment, the molecular sieve is SAPO-34. In another embodiment, the catalyst comprises two or more different SAPO molecular sieves selected from the group consisting of AEI, AFX, CHA, LEV, and LTA.

Preparing SAPO molecular sieves is generally known. For example, one method comprises mixing sources of alumina, silica, and phosphate with a TEAOH solution or other organic structural directing agents (SDA) and water to form a gel. The gel is heated in an autoclave at a temperature ranging from 150 to 180° C. for 12-60 hours, and then cooling and optionally washing the product in water. And finally, calcining the product to form a molecular sieve having the desired thermostability. Still other techniques will be apparent to prepare suitable molecular sieves of the present invention in light of this disclosure

As is known, to enhance its catalytic properties, the catalyst is loaded with a limited amount of one or more transition metals (TMs). Suitable transition metals include, for example, Cr, Mn, Fe, Co, Ce, Ni, Cu, Zn, Ga, Mo, Ru, Rh, Pd, Ag, In, Sn, Re, Ir, Au, Pr, Nd, W, Bi, Os, and Pt. In one embodiment, the transition metal is Cu or Fe or combinations thereof. In one particular embodiment, the transition metal is Cu.

As mentioned above, an important aspect of the present invention is the limited TM loading required. In one embodiment, the transition metal loading is less than about 1 wt % of the catalyst, in a more particular embodiment, the transition metal loading is less than about 0.5 wt %, and, in an even more particular embodiment, the transition metal loading is less than about 0.3 wt %.

The TM may be loaded into the molecular sieve using any know technique including, for example, incipient wetness impregnation, liquid-phase or solid-state ion-exchange, spray drying, coextrusion, or incorporated by direct-synthesis. In one embodiment, the TM is loaded using spray drying. In one embodiment, the material, such as SAPO-34, is cation exchanged with iron, wherein the iron oxide comprises at least 0.01 wt % of the total weight of the material. In another embodiment, the material, such as SAPO-34, is cation exchanged with copper, wherein copper oxide comprises at least 0.01 wt % of the total weight of the material.

SCR catalysts may comprise a substrate manufactured from a ceramic material, such as cordierite, mullite, silica, alumina, titania, or their combinations. Alternatively, the substrate can be metallic. The two most common substrate designs are monolith or plate and honeycomb. Plate-type catalysts have lower pressure drops and are less susceptible to plugging and fouling than the honeycomb types, but plate configurations are much larger and more expensive. Honeycomb configurations are smaller than plate types, but have higher pressure drops and plug much more easily. Alternatively, the catalyst may be an extruded with or without a substrate. In the latter embodiment, the catalyst has no discrete substrate. In yet another embodiment, the catalyst is not supported at all, but provided in bulk.

In one embodiment, the catalyst is part of compound catalyst comprising two or more catalysts. For example, the compound catalyst may comprise not only an SCR catalyst but also an oxidation catalyst for converting excess NH3 or fuel. Such a compound catalyst may comprise alternating layers/stripes of different catalysts, or the catalysts may be mixed together and applied to a substrate. In other embodiment, the catalyst also comprises a scavenger to remove/absorb extra NH3. Again, such a compound catalyst may comprise alternating layers/stripes of the catalyst and scavenger, or the catalyst and scavenger may be mixed together and applied to the substrate.

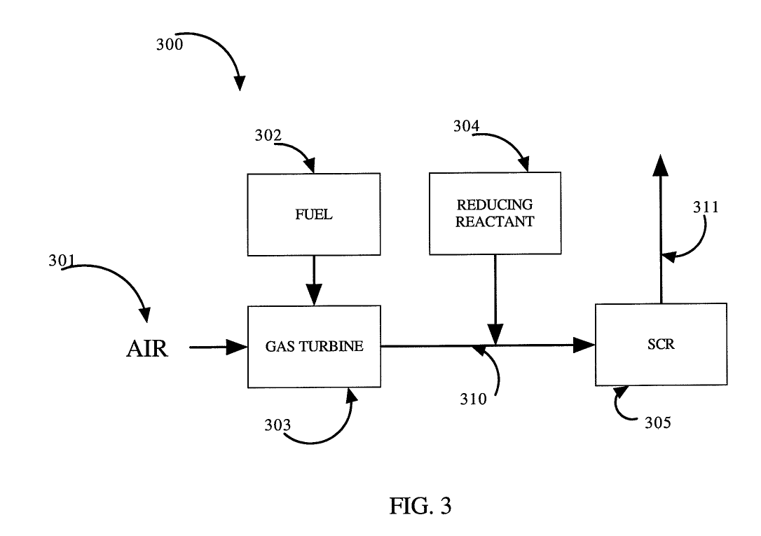

FIG. 3 is a schematic of a gas turbine system 300 with an air input 301, a fuel input 302, a gas turbine 303, combustion exhaust stream 310, a reducer (ammonia) injector 304, a selective catalytic reduction bed 305, and a cleaned exhaust stream 311. These elements are considered in greater detail below.

The exhaust stream 310 existing the gas turbine 303 is characterized in that it contains relatively low levels of NOx, for example, <50 ppm. The exhaust stream 310 is also relatively hot, having a temperature of about 800 to about 1200° F.

Downstream of the turbine 303 is the injector 304 for injecting nitrogenous reductant into the exhaust flow. Several reductants may be used in SCR applications, including, for example, ammonia per se, hydrazine, anhydrous ammonia, aqueous ammonia or an ammonia precursor selected from the group consisting of urea ((NH₂)₂CO), ammonium carbonate, ammonium carbamate, ammonium hydrogen carbonate and ammonium formate. Pure anhydrous ammonia is toxic and difficult to safely store, but needs no further conversion to react with an SCR catalyst. Urea is the safest to store, but requires conversion to ammonia through thermal decomposition and hydrolysis in order to be used as an effective reductant. In place of ammonia, a compound which can readily be decomposed into ammonia, for example, urea, can be used for this purpose.

As is known, the injector 304 is controlled by a controller (not shown) which monitors a number of turbine and exhaust parameters and determines the appropriate amount of nitrogenous reductant to inject. Such parameters include, for example, exhaust gas temperature, catalyst bed temperature, load, mass flow of exhaust gas in the system, manifold vacuum, ignition timing, turbine speed, lambda value of the exhaust gas, the quantity of fuel injected in the turbine and the position of the exhaust gas recirculation (EGR) valve and thereby the amount of EGR and boost pressure.

Ammonia is injected through nozzles installed within an ammonia distribution grid that is located a short distance from the face of the SCR catalyst reduction bed 305. The short distance between the ammonia injection grid and the face of the SCR is required to minimize the decomposition of ammonia at high temperatures of the exhaust above 1000° F. As a result, a short NH3/NOx mixing zone can lead to a severe maldistribution effect and can significantly reduce the performance of the SCR downstream. To overcome this problem special distribution/straightening and mixing devices need to be installed upstream of the SCR bed in order to provide a good mixing between NH3 and NOx upstream of the SCR. Such mixing devices are well known in the art.

Following the injector 304 is the SCR catalyst reduction bed 305. It is situated to contact the exhaust gas and reduce the NOx using a nitrogenous reductant to form N2 and resulting in a NOx-reduced gas stream. In order to achieve high NOx reduction efficiency, a slight abundance of nitrogenous reductant will be injected into the exhaust stream resulting in a portion of it passing through the SCR and entering the NOx reduced gas stream. This is referred to as slipped nitrogenous reductant or, more particularly, slipped ammonia.

### EXAMPLES

The following non-limiting examples compare two embodiments of the combined catalyst of the present invention to a traditional SCR catalysts.

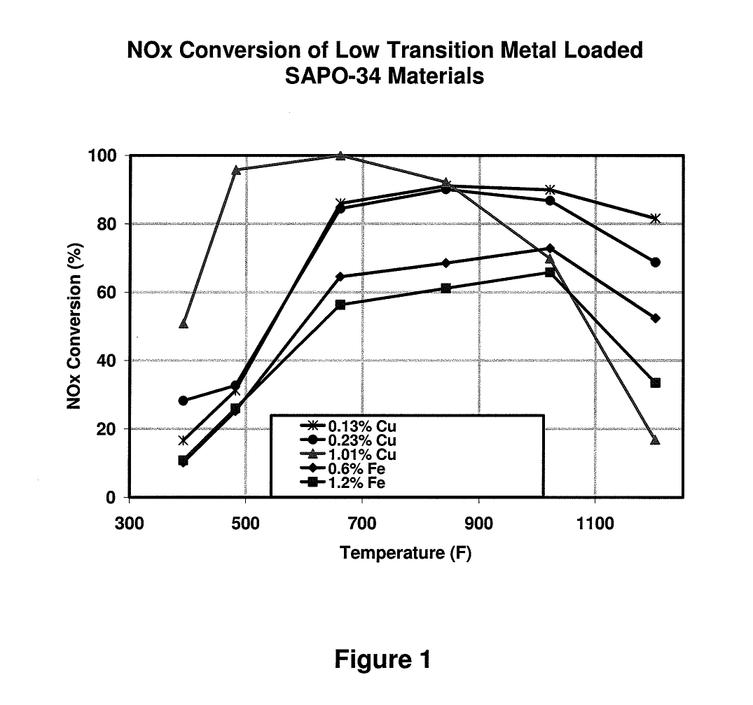

The effectiveness of the relatively low-loaded SAPO molecular sieves is shown in FIG. 1 in comparison to more-heavily loaded sieves. Specifically, SAPO-34 was loaded with a relatively low concentration of copper, 0.13 and 0.23 wt %, and iron, 0.6 wt. %. Comparative samples were loaded more heavily at 1.01 wt. % Cu and 1.2 wt. % Fe. All the samples were evaluated at a space velocity of 10,000 h⁻¹ over a temperature range of 300 to 1200° F. While all of the samples show good conversion rates at between around 700 to around 1000° F., the conversion rates of the more-heavily loaded SAPO-34 samples show a precipitous drop after 1000° F. This indicates a drop in selectively of the more-heavily loaded SAPO samples, causing the oxidization of NH3 and diminishing the available reducing agent for NOx reduction, thereby reducing the conversion of NOx. Conversely, the relatively low loaded SAPO samples show significantly higher conversion rates above 1000° F., thus indicating continued high selectively of NOx over NH3.

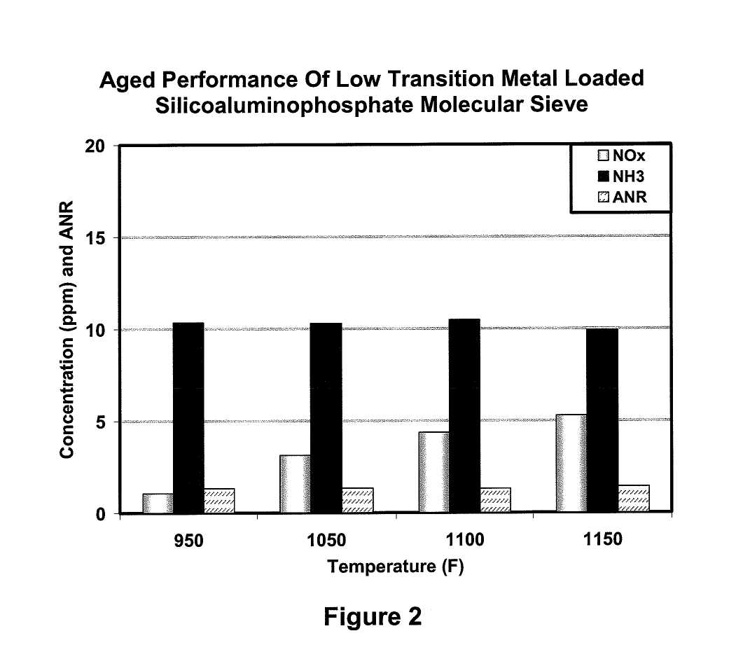

Referring to FIG. 2, the effectiveness of aged low transition metal loaded SAPO molecular sieves is shown. After 2000 hours of hydrothermal aging at 1200° F. in 4.5% water in air, a low 0.21% Cu SAPO-34 catalyst still achieves emission requirements of 10 ppm NH₃ slip and 5 ppm NOx slip from a feed stream of 42 ppm NOx at a space velocity of 12,000 h⁻¹.

It should be understood that the foregoing is illustrative and not limiting and that obvious modifications may be made by those skilled in the art without departing from the spirit of the invention. Accordingly, the specification is intended to cover such alternatives, modifications, and equivalence as may be included within the spirit and scope of the invention as defined in the following claims.

What is claimed is:

1. A catalyst comprising:
a microporous crystalline molecular sieve comprising at least silicon, aluminium and phosphorous and having an 8-ring pore size; and
a transition metal loaded in said molecular sieve, said transition metal being present such that the transition metal loading is less than about 1 wt % of said catalyst.

2. The catalyst of claim 1, wherein said transition metal loading is less than about 0.5 wt %.

3. The catalyst of claim 1, wherein said molecular sieve is a silicoaluminophosphate.

4. The catalyst of claim 3, wherein silica content is greater than 5%.

5. The catalyst of claim 3, wherein said molecular sieve has a CHA framework type.

6. The catalyst of claim 5, wherein said molecular sieve is SAPO-34.

7. The catalyst of claim 1, wherein said transition metal is Cr, Mn, Fe, Co, Ce, Ni, Cu, Zn, Ga, Mo, Ru, Rh, Pd, Ag, In, Sn, Re, Ir, Au, Pr, Nd, W, Bi, Os or Pt, and combinations thereof.

8. The catalyst of claim 7, wherein said transition metal is Cu, Fe, or combinations thereof.

9. The catalyst of claim 8, wherein said transition metal is Cu.

10. The catalyst of claim 1, further comprising a substrate on which said microporous material is disposed.

11. The catalyst of claim 10, wherein said substrate is a honeycomb substrate or plates.

12. A method reducing NOx emission from a stationary gas turbine, said method comprising:
injecting nitrogenous reductant into an exhaust flow from said gas turbine containing NOx and having a temperature greater than 850° F.;
contacting said exhaust stream containing said reductant with an SCR catalyst to form a NOx-reduced gas stream, said SCR catalyst comprising at least
a microporous crystalline molecular sieve comprising at least silicon, aluminium and phosphorous and having an 8-ring pore size; and
a transition metal loaded in said molecular sieve, said transition metal loading is less than 1 wt %.

13. The method of claim 12, wherein said NOx conversion rate is at least 80% at an operating temperature of about 850 to about 1200° F.

14. The method of claim 12, wherein said SCR catalyst achieves greater than 80% NOx reduction efficiency at an NH3:NOx ratio less than 2.

15. The method of claim 12, wherein said molecular sieve is a silicoaluminophosphate.

16. The method of claim 16, wherein said molecular sieve has a CHA framework type.

17. The method of claim 17, wherein said molecular sieve is SAPO-34.

18. The method of claim 12, wherein said transition metal is Cr, Mn, Fe, Co, Ce, Ni, Cu, Zn, Ga, Mo, Ru, Rh, Pd, Ag, In, Sn, Re, Ir, Au, Pr, Nd, W, Bi, Os or Pt, and combinations thereof.

19. The method of claim 18, wherein said transition metal is Cu, Fe, or combinations thereof.

20. The method of claim 19, wherein said transition metal is Cu.
